(19) United States
(12) Patent Application Publication
(10) Pub. No.: US 2010/0205196 A1
(43) Pub. Date: Aug. 12, 2010

(54) Virtual File System for the Web

(75) Inventors: Zvi Schreiber, Jerusalem (IL); Yousef Abdalkaream Mustafa Ghandour, Kufur Aqab (IL)

Correspondence Address: SIMON KAHN - PYI Tech, Ltd.;c/o LANDONIP, INC, 1725 Jamieson Avenue, ALEXANDRIA, VA, 22314, US

(73) Assignee: GHOST, INC., Tortola (VG)

(21) Appl. No.: 12/530,463

(22) PCT Filed: Mar. 9, 2008
(86) PCT No.: PCT/IL08/00321

§ 371 Date: Jan. 27, 2010

Related U.S. Application Data
(60) Provisional application No. 60/893,968, filed on Mar. 9, 2007.

(51) Int. Cl. G06F 17/30

(52) U.S. Cl. 707/758; 707/827; 707/E17.01; 707/E17.014; 726/8

(57) ABSTRACT

Uniform access to files across multiple Web services, each of which hosts files and optionally folders but which have different paradigms, different user accounts, and different APIs is provided. In one embodiment the uniform representation is responsive to a uniform API; and an adapter functionality arranged to adapt commands of the uniform API to the respective particular API of the respective third party Web based services which do not support the uniform API.

### CROSS-REFERENCE TO RELATED APPLICATIONS

This application claims priority from U.S. Provisional Patent Application Ser. No. 60,893,968 filed Mar. 9, 2007, entitled “Virtual Hosted Operating System” the entire contents of which is incorporated herein by reference.

This application is further related to the following co-pending, co-filed and co-assigned patent applications, the entire contents of each of which are incorporated herein in their entirety by reference: “A VIRTUAL IDENTITY SYSTEM AND METHOD FOR WEB SERVICE”, docket GHO-005-PCT; “A GENERAL OBJECT GRAPH FOR WEB USERS”, docket GHO-007-PCT; “SYSTEM AND METHOD FOR BROWSER WITHIN A WEB SITE AND PROXY SERVER” docket GHO-008-PCT; and “SYSTEM AND METHOD FOR A VIRTUAL HOSTED OPERATING SYSTEM” docket GHO-009-PCT.

### BACKGROUND OF THE INVENTION

The field relates to computer software and Web services and more particularly to managing file systems from multiple Web services.

Recently there has been a proliferation of Web-based services which are accessed using a browser. Many of the Web based services provide file storage in a proprietary manner for files of the service. For example, certain Web-based service provide on line Web based storage for pictures, others provide on line Web based storage for files, while yet others provide on line storage for e-mail correspondence.

Unfortunately, management of these disparate systems is not unified. For example, for a user that has pictures stored on one Web-based service, and files stored on another service, who wishes to combine them into a single document or presentation, is faced with the process of accessing each individual service, finding the file of interest or picture, and copying it into the document. Such a process is cumbersome, and far from intuitive.

Access to each third party Web service provider typically requires a logon, and furthermore each third party Web service provider typically has its own proprietary application programming interface (API) which is used for automated access.

What is needed, and not provided by the prior art, is a common system and method for accessing files across multiple Web-based services.

### SUMMARY OF THE INVENTION

Certain embodiments of the invention take multiple Web services, each of which hosts files and optionally folders but which have different paradigms, different user accounts, and different APIs, and provides a virtual file system layer to allow uniform access.

In certain embodiments the invention provides for a computer implemented virtual file system comprising a uniform representation of a plurality of file systems hosted by respective different third party Web based services.

In one further embodiment, the uniform representation comprises: a uniform application programming interface (API); and an adapter functionality arranged to adapt respective third party Web based services which do not support the uniform API to the uniform API. In another further embodiment in the event that the particular API of one of the respective third party Web based services does note support HTTP methods other than GET and POST, at least one other command is implemented by using one of GET and POST with a parameter.

In one further embodiment the uniform API uses a single tree of URLs at the same domain for the plurality of file systems which have distinct domains. In another further embodiment the computer implemented virtual file system further comprises a search capability operative across the plurality of file systems.

In one further embodiment each of the plurality of file systems is displayed as a virtual drive. In one yet further embodiment each of the plurality of file systems exhibits metadata specifying its location and capabilities.

In one further embodiment the computer implemented virtual file system further comprises a client code arranged to navigate the virtual file system. In one yet further embodiment the client code is implemented as an interactive web page. In one yet further embodiment the client code is operative to add a file system responsive to a Universal Record Locator. In another yet further embodiment the Universal Record Locator represents an address of one of a metadata for the file system and an application programming interface for the file system.

In one further embodiment the file system is further operative to enable a user to add tags from one master list of tags to files from each of the plurality of file systems. In another further embodiment the file system is further operative to enable users to share files via the uniform representation. In one yet further embodiment the computer implemented virtual file system further comprises a repository of identity information for users, wherein the file sharing is controlled by the respective third party Web based service hosting the file to be shared, and wherein the virtual file system is further operative to mark the file to be shared as shared by accessing the respective third party Web based service utilizing identity information from the repository. In another yet further embodiment the computer implemented virtual file system further comprises a repository of identity information for users, wherein the virtual file system is operative to retrieve the file to be shared by a second user by accessing the respective third party Web based service utilizing identity information of the owner of the file from the repository.

In one even further embodiment the identity repository is coupled to a single sign on functionality. In another even further embodiment the single sign functionality supports multiple protocols, and preferably one of the protocols is digest access authentication.

In certain embodiments the invention independently provides for a computer implemented method of uniform representation of a plurality of file systems hosted by respective different third party Web based services, comprising: receiving commands to access a file hosted by one of the respective different third party Web based services; preparing the command utilizing a uniform application programming interface (API); adapting, in the event that the one of the respective different third party Web based services does not support the uniform API, to an API supported by the one of the respective different third party Web based services; and transmitting the prepared command in the supported API to the one of the respective different third party Web based services.

In one further embodiment in the event that the particular API of the one of the respective third party Web based service does note support HTTP methods other than GET and POST, the adapting comprises using one of GET and POST with a parameter. In another further embodiment the uniform API uses a single tree of URLs at the same domain for the plurality of file systems which have distinct domains.

In one further embodiment the computer implemented method according further comprises: enabling a search operative across the plurality of file systems. In another further embodiment each of the plurality of file systems is displayed as a virtual drive.

In one further embodiment each of the plurality of file systems exhibits metadata specifying its location and capabilities. In another further embodiment the computer implemented method further comprises: providing a client code arranged to navigate the virtual file system.

In one yet further embodiment the client code is implemented as an interactive web page. In another yet further embodiment the client code is operative to add a file system responsive to a Universal Record Locator, and preferably the Universal Record Locator represents an address of one of a metadata for the file system and an application programming interface for the file system.

In one further embodiment the computer implemented method further comprises: enabling a user to add tags from one master list of tags to files from each of the plurality of file systems. In another further embodiment the computer implemented method further comprises: enabling users to share files via the uniform representation. In one yet further embodiment the enabling users to share files comprises: providing a repository of identity information for users; accessing the respective third party Web based service utilizing identity information from the repository; and marking the file to be shared.

In another yet further embodiment the enabling users to share files comprises: providing a repository of identity information for users; and retrieving the file to be shared by a second user by accessing the respective third party Web based service utilizing identity information of the owner of the file from the repository.

In one even further embodiment the identity repository is coupled to a single sign on functionality. In another even further embodiment the single sign functionality supports multiple protocols. Preferably, one of the protocols is digest access authentication.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a system architecture, according to certain embodiments of the invention, operable to provide uniform access to files from third party Web service providers;

FIG. 2 illustrates a home application with a third party Web based application embedded in an IFrame according to certain embodiments of the invention;

FIGS. 3A and 3B, which together form a single figure, illustrate a UML class diagram for capturing a directory of third-party web services including their authentication schemes and for capturing a user's third-party login credentials, according to certain embodiments of the invention;

FIG. 4 illustrates a high level block diagram of virtual file system according to certain embodiments of the invention;

FIG. 5 illustrates a unified user interface for files from third party Web service providers according to certain embodiments of the invention;

FIG. 6 illustrates a user interface for adding a drive to the virtual file system according to certain embodiments of the invention;

FIG. 7 illustrates a high level flow chart of a method of sharing files using a third party infrastructure, in accordance with certain embodiments of the invention;

FIG. 8 illustrates a high level flow chart of a method of sharing files without using a third party infrastructure, in accordance with certain embodiments of the invention;

FIG. 9 illustrates a high level flow chart of a plurality of methods according to an embodiment of an invention to automatically generated a signed API call to a third party Web service provider; and

FIG. 10 illustrates a high level flow chart of a method of sharing files by embedding a third party client, in accordance with certain embodiments of the invention.

### DETAILED DESCRIPTION OF THE PREFERRED EMBODIMENTS

The present embodiments enable uniform access to files across multiple Web services, each of which hosts files and optionally folders but which have different paradigms, different user accounts, and different APIs.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

### Overall Architecture

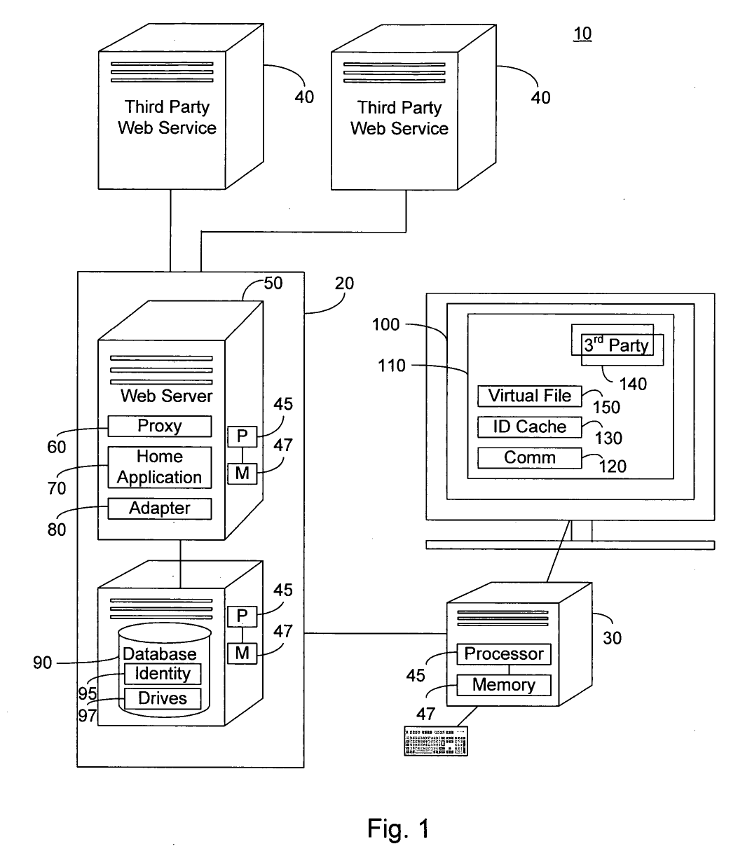

FIG. 1 illustrates a high level block diagram of a system architecture 10, according to certain embodiments of the invention, operable to provide uniform access to files across multiple Web services. System architecture 10 comprises a system server 20, a user computer 30, and a plurality of third party Web based services 40. System server 20 comprises a Web server 50 exhibiting: an optional proxy functionality 60; a home application functionality 70; an adapter functionality 80; and a database 90. User computer 30 is shown running a client code 110 of the home application within a Web browser 100. Client code 110 further exhibits a communication module 120, and optional identity cache 130; one or more optional IFrames 140; and a virtual file system client 150. Each of Web server 50, database 90 and user computer 30 comprise a respective processor 45 and a memory 47 in communication with the respective processor 45. Database 90 comprises an identity repository 95 and a drives directory 97.

A single system server 20 is illustrated, however this is not meant to be limiting in any way. In another embodiment, a series of system servers 20 are provided. System server 20 hosts the server code of the home application in home application functionality 70, the server code of proxy functionality 60, the server code of adapter functionality 80 and the identity management system of the home application. Preferably, system server 20 further provides a full hosted virtual operating system via a virtual hosted operating system functionality, (not shown) and further described in in co-pending patent application “SYSTEM AND METHOD FOR A VIRTUAL HOSTED OPERATING SYSTEM” the entire contents of which is incorporated herein by reference. Each of proxy functionality 60, home application functionality 70 and adapter functionality 80, represent software code stored on memory 47 of Web server 50 and processed by processor 45 of Web server 50.

Two third party Web based services 40 are illustrated, however this is not meant to be limiting in any way, and three or more disparate third party Web based services 40 are specifically within the scope of the invention. In accordance with certain embodiments of the invention, third party Web based services 40, which offer on-line storage which may be accessed over the Internet, are preferably considered virtual drives. Thus, the term “drives” as used throughout this document specifically includes third party Web accessible file storage services 40.

In operation, a user accesses the system from a computer 30, which is preferably remote from system server 20. Computer 30 runs a Web browser 100, shown displayed on a monitor of computer 30. There is no requirement that computer 30 be a fully functional computer, having various user accessible programs, other than Web browser 100. Computer 30 thus may be constituted of a personal computer, computer terminal, a thin-client computer, a personal computer, a mobile phone or a set-top box without exceeding the scope of the invention. In general computer 30 is a device allowing access to the Web, and providing for user input.

Client code 110 preferably runs within Web browser 100. Preferably, client code 110 is dynamically downloaded by Web browser 100 from system server 20. In one embodiment, client code 110 contains a sequence of static HTML pages generated at system server 20 using known technologies such as JSP or ASP. In another embodiment, client code 110 is constituted of code that executes within the Web browser 100 using one or more of: FLASH; Java Applet; Active-X; and DHTML+Javascript, known as AJAX.

The above has been described in an embodiment in which client code 110 is downloaded from system server 20 by Web browser 100, however this is not meant to be limiting in any way. In another embodiment, client code 110 is software installed on, or embedded within, computer 30 and does not run in a browser.

### Identity Repository

An optional identity management application preferably realized as a Web application helps the user to manage their repository of identity information. The identity information, input via the Web application is stored on database 90 in identity repository 95. In one embodiment database 90 is a relational database, available from Oracle Corporation of Redwood Shores, Calif. In another embodiment database 90 is a third-party database service such as SimpleDB from Amazon Inc. of Seattle, Wash. Home application functionality 70 comprises business logic running on web server 50. In one embodiment home application functionality 70 is constituted of one of a Java servlets or CGI scripts.

Database 90 is illustrated as a server in communication with Web server 50, however this is not meant to be limiting in any way. In another embodiment, database 90 is constituted of a database functionality provided on Web server 50. In operation, identity repository 95 maintains a user's information, including third-party usernames and passwords, and optionally temporary session ID's as will be described further below. In one embodiment, identity repository 95 further maintains data on available third-party applications and on their SSO capabilities.

Client code 110 preferably comprises an identity cache 130 operative to store third party identity information including login information such as username and/or password and/or temporary sessionID. The contents of identity cache 130 are retrieved as required from database 90 and cached in volatile memory, preferably with standard encryption. Identity cache 130 optionally further stores the status of whether a third-party cookie is present in Web browser 100 which grants access to a third-party service.

### Communication

Client code 110 is further provided with communication module 120, which is operative to send requests to home application system server 20 and in particular to proxy functionality 60 and home application functionality 70. In one embodiment, the requests are sent from communication module 120 using standard Hypertext Transfer Protocol (HTTP) requests. In a further embodiment, the HTTP requests are consonant with the design principals of Representational State Transfer, known to those skilled in the art. In another embodiment the HTTP requests are encoded according to the XML-RPC remote call protocol. In yet another embodiment the HTTP requests are consonant with the SOAP protocol. In one embodiment communication module 120 performs authentication on outgoing API calls. In one further embodiment the authentication is Digest Access Authentication.

Web-based Distributed Authoring and Versioning, or WebDAV, is a set of extensions to HTTP which allows users to collaboratively edit and manage files on remote World Wide Web servers. Specifically, WebDAV is a standard set of APIs consistent with the principals of REST. In certain embodiments, WebDAV is implemented as the API or part of the API of a virtual file system of the subject invention.

### Proxying

In one embodiment, proxy functionality 60 is operative to forward requests from client code 110 to the appropriate third party Web based service 40, given that Web browser 100 will often act to prevent client code 110 from communicating with any domain other than the domain it was downloaded from. As indicated above, client code 110 is downloaded from web server 20, and thus client code 110 is restricted to communication with web server 20.

Such proxying is commercially available, e.g. as part of the Laszlo Presentation Server (LPS) from Laszlo Inc. (www.laszlosystems.com) of San Mateo, Calif. or the CGI-Proxy product from James Marshall of Berkeley, Calif. (http://www.jmarshall.com/tools/cgiproxy/). In order to implement this, preferably client code 110 is operative to intercept at least the first request by the user to communicate with third party Web service provider 40, and route the request to proxy functionality 60, passing the target URL as a parameter. In a non-limiting example, instead of sending HTTP request: “GET thirdpartyservice.com” directly, client code 110 will send HTTP request “GET proxy.home-application.com?url=thirdpartyservice.com”. Proxy functionality 60, which is not subject to the limitations which Web browser 100 places on client code 110, is operative to forward this request to its destination.

In one embodiment, proxy functionality 60 is further operative to perform additional services such as one or more of: attaching user's cookies to the forwarded request; and “proxifying” the response, in case it is a web page, so that any hyperlinks or other network calls in the returned web page are themselves adjusted to access the network via the proxy server.

In one embodiment, the proxy server is further operative to add authentication information to calls before forwarding them to the third-party. In one further embodiment the added authentication information is accomplished using the Digest Access Authentication protocol.

The above description is enabling for one skilled in the art. Additionally, operation of the proxy server is further described in co-pending patent application “SYSTEM AND METHOD FOR BROWSER WITHIN A WEB SITE AND PROXY SERVER”, the entire contents of which is incorporated herein by reference.

### Adapters

Adapter functionality 80 is operative to present a standardized API in front of the proprietary APIs of the third party Web based services. Adapter functionality 80 represents software code run on Web server 50 by its processor 45 in cooperation with its memory 47, however this is not meant to be limiting in any way. In one embodiment, a third party Web service 40 may run adapter functionality 80 and thus support standard APIs. A single adapter functionality 80 is shown, however this is not meant to be limiting in any way, and the use of multiple adapters, each arranged to adapt the standards, is also possible. Adapter functionality 80 may also present drive metadata and participate in performing single sign-on

For example, at the time of the filing of this application, certain popular Web accessible file storage services such as Google Docs and Flickar do offer APIs but do not offer a standards based API such as WebDAV.

Thus, adapter functionality 80 is operative to provide a standardized API recognized by home application 70 over the appropriate API of the third party Web based service. In one embodiment drives directory 97, to be described further below, maintains information regarding the appropriate API for use with each third party Web based service provider 40. In one further embodiment, the stored information comprises a call to the appropriate adapter functionality 80.

Drive Metadata

As indicated above, on line storage facilities of third party Web based services 40, are essentially virtual drives. In certain embodiments of the invention, uniform access to files across multiple Web based services 40 is achieved by treating each of the third party Web based services 40 as virtual drives which may be added to the uniform file system. Preferably every third party Web based service 40 provides some metadata about its own capabilities either natively or in the respective adapter functionality 90. In one embodiment, the capabilities are put in an XML file made available at a URL using a standard Web server. Thus, in order to add a virtual drive to a users virtual file system, a user who want to add a drive to the system need only specify the URL of the drive metadata file and client code 110 will read all parameters of the drive from that URL.

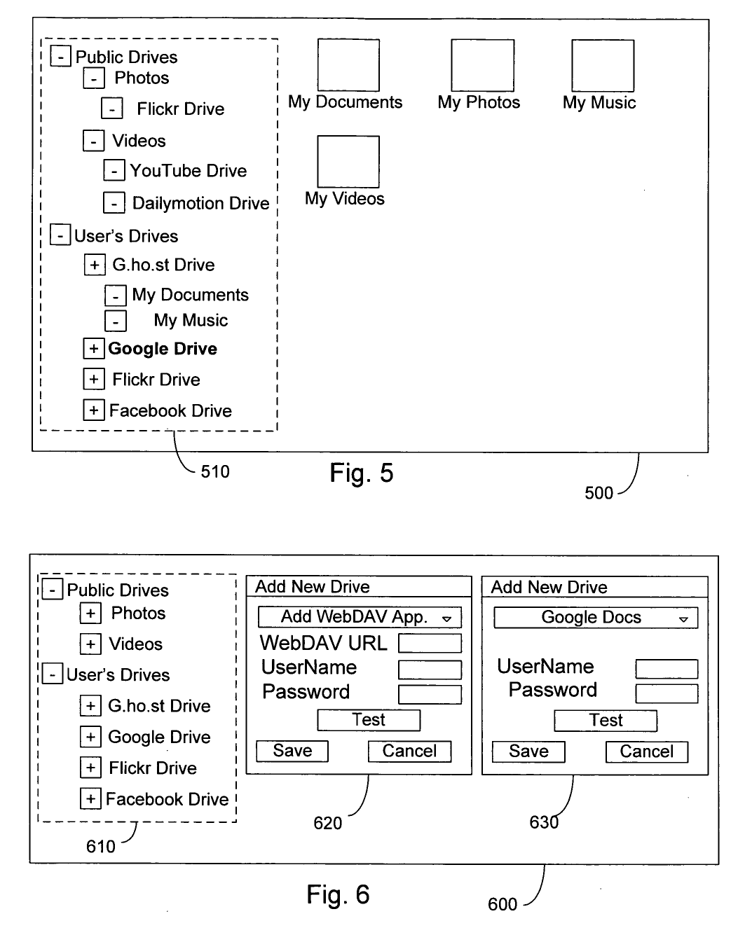

FIG. 6 illustrates a user interface 600 for adding a virtual drive to the virtual file system according to certain embodiments of the invention. User interface 600, a portion of virtual file system client 150, comprises file directory listing 610, a WebDAV dialog box 620 for mounting drives using a URL of a WebDAV server, and a drive dialog box 630 for adding drives from pre-configured service providers such as Google Docs. WebDAV dialog box 620 illustrates the selection by URL of the third party web based service 40, however in another embodiment a similar dialog enables the selection of a URL of a different standards based API (of a service or of its adapter) or of the metadata file which would then be used to find both the WebDAV URL and further data.

Advantageously, by placing metadata in an XML file on the Web, various search engines can find new drives. Such metadata may be supplied either by the third party Web based service provider 40 or by another party unrelated to third party Web based service provider 40. In particular, the virtual drive metadata file includes some or all of:
Legal name of service provider;
Name of service;
Description of service;
Icons for service, preferably in a plurality of sizes;
URL of terms of service;
URL of sign-up;
URL of WebDAV interface (whether native or adapter), also URL for other supported protocols such as FTP;
Authentication protocols and parameters supported, including API for generating a sessionID (or temporary password) if supported;
Free quota per account;
Price list for extra storage, for example a list of entries each of which has #MB, term in days/months/years, currency, price;
List of extensions supported including wild card (e.g. .doc, .jpg);
Are folders supported?;
Are folder hierarchies supported?;
Are tags supported?;
File metadata provided by systems, such as file size? Folder contents size? Date created? Date modified?;
User metadata for files—including: Supported?; Max number of name value pairs?; and Max length of each name, value; and
Methods provided in API: such as Create empty file? Rename? Move? Read file? Write file? Append file? Random access to part of a file? Search for files by name? Search file contents?

It is to be noted that a subset of this information is provided in the Application Description File [ADF] specified by OpenSAM, available from http://opensam.org.

### Server for File System

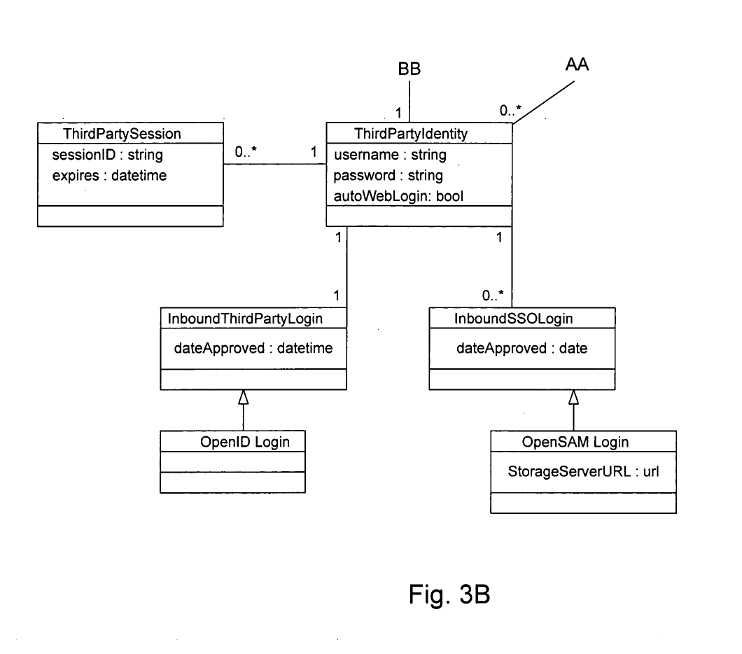

FIG. 4 illustrates a high level block diagram of virtual file system according to certain embodiments of the invention, and in particular a high level design for the main business logic within the Web server 50. On the right are shown certain hosted file system services or services which include file system known as virtual drives. G.ho.st storage 410 is an example of a file storage service commercially and technically associated with the Virtual file system service according to certain embodiments of the invention, in that it is also supported by system server 20. Hosted services 420 represents third party Web based services, or virtual drives, which may or may not natively support WebDAV or may support WebDAV via an adapter hosted by the third-party Web based service.

The central rectangle shows a business logic 430 run on system server 20, and in particular on Web server 50, and preferably as a portion of home application functionality 70. An object resource 440 provides reusable object-oriented objects, e.g. in Java running in servlets, to represent files and folders manipulated in the system. A method resource 450 provides object-oriented encapsulation for the methods offered in a file system such as list, copy, move, rename and create, without limitation.

Implementation module 460 provides an abstract implementation for the specific requests and responses processed by the Virtual file system and specific implementations for the case that the virtual drive (a) natively supports the abstractions of object resource 440 and method resource 450; (b) for WebDAV; (c) other implementations, in which the same object-oriented classes or interfaces are realized in a manner similar to that described above in relation to adapter functionality 80.

Preferably business logic 430 includes an external API 470 which preferably includes support for WebDAV and an extension API 475 which supports some extensions, denoted WebDAV+, such as search and share which are not supported in WebDAV.

In one embodiment all queries about files and folder metadata are passed through business logic 430; however reading and writing of the content of files is done directly from virtual file system client 150 to the virtual drives G.ho.st storage 410 and hosted services 42. In embodiment this is implemented by an HTTP redirect.

### Virtual File System Client

Virtual file system client 150 is preferably realized as an interactive Web page using techniques including static html pages generated by JSP or ASP, or preferably using client-side scripting in Flash, AJAX, Silverlight or Java applets or in a higher level language such as OpenLaszlo from Laszlo Inc. of San Mateo, Calif. In another embodiment virtual file system client 150 is deployed as an installed application such as a Windows application or in an offline simulator of a Web environment such as Adobe AIR.

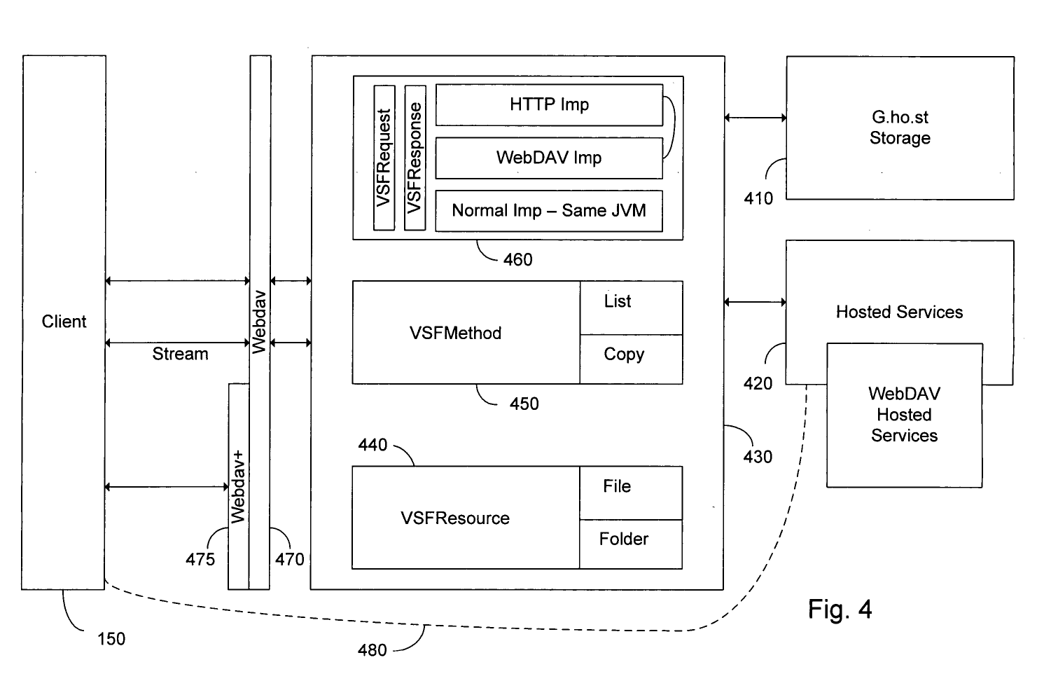

FIG. 5 illustrates a unified user interface 500 for files from third party Web service providers' according to certain embodiments of the invention, as an aspect of virtual file system client 150. Panel 510 shown on the left shows a list of available drives optionally organized into private, public and possibly shared drives. Optionally drives are organized by file type (e.g. video) and/or by service provider (e.g. Google). Optionally buttons and dialogs are available for adding drives by preconfigured service provider or by URL as described above in relation to FIG. 6.

Navigation within drives is preferably compatible with navigation within well know programs such as Windows File Explorer, from Microsoft Corp. Within each drive optionally the user can navigate files by folder hierarchy, by tag, by date. Furthermore, the user can search all of the drives by any of file name, file contents and metadata. Optionally files may be displayed as lists, in detailed tabular format, using small or big icons, without extra data on mouseover and with extra operations provided in right-click context menus.

Advantageously, virtual file system client 150 adds value by providing search across multiple drives and by allowing moving and copying files, without limitation, between different drives, provided the drives support the relevant file types and have read and write capabilities respectively. In one embodiment, moving and copying files is performed by dragging and dropping with a mouse.

In one embodiment, each file from any drive is shown as an icon which may also show by way of a smaller sub-icon or mouse-over data indicators of one or more of:
Which service provider hosts the file;
Which drive, e.g. third-party name;
Who created/if shared; and
Typical file metadata like file type, optionally indicated by an extension like .doc, file size and create/modified date.

### Federated Services

In certain embodiment virtual file system client 150, in cooperation with adapter functionality 80, is operative to provide consistent APIs to many virtual drives including optionally a single tree of URLs in one domain.

### Search

In certain embodiment virtual file system client 150, in cooperation with adapter functionality 80, provides the ability to find files by providing a subset of the file names or by providing keywords inside the file and/or by specifying ranges for metadata such as last-modified or create date. In one embodiment this is implemented by sending the search to all drives of interest, preferably in parallel, waiting for all responses and then collating the results. Alternatively, web server 50 may create indexes for file names or file content keywords or file metadata such indexes spanning multiple file systems for quicker searching.

### Tags

In certain embodiment, virtual file system client 150 enables the user to add tags to files using one set of tag names spanning all virtual drives. Tags may be added to the metadata of the file within the virtual drive, if supported. In an alternative embodiment tags are stored in drives directory 97 of database 90 or in a separate database (not shown). In one embodiment a record of a tag contain one or all of:
Tag name;
User name;
Service provider name;
Drive identifier, e.g. third-party name; and
File identifier (e.g. path and file name or preferably a unique identifier if supported).

In another embodiment, a separate database table or domain is used to list all the tags which a user has created and optionally a count of how many times each is used so that it can be displayed more prominently.

### Sharing

In certain embodiment virtual file system client 150, in cooperation with adapter functionality 80, allows the owner of a file to share access (e.g. for read or read/write) to a file or folder with other users in a way which is independent of the specific drive it is on.

Sharing using Third-Party Infrastructure

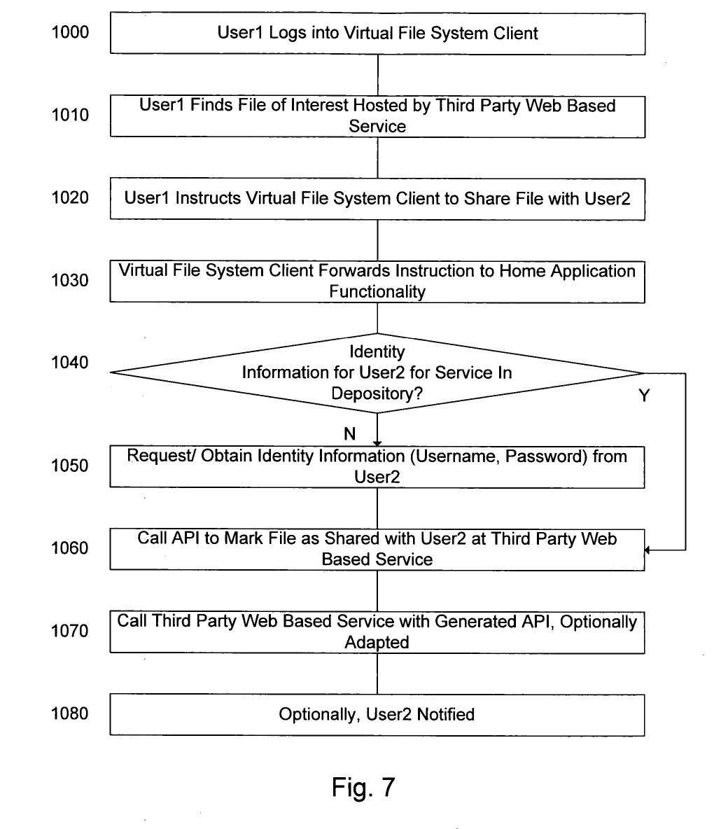

In one embodiment sharing is left to the third-party Web based service 40. Preferably, one of the APIs exposed by the third party is sharing. When a user asks virtual files system client 150 to share a file hosted at a given service provider with a second user, virtual files system client 150 determines how the third-party Web based service 40 identities the second user and then transfers the command to third-party Web based service 40. A typical workflow method, describing sharing files using third party infrastructure is described below in relation to FIG. 7.

In stage 1000, User 1, logs into virtual file system client 150 and in stage 1010 uses virtual file system client 150 to find a file hosted by a first third party Web based service, denoted Service1, in User 1's account—i.e. User1@Service1.com with file unique ID xyz. In stage 1020, User 1 instructs virtual file system 150 to share the file of stage 1010 with User2.

In stage 1030, virtual file system client 150 forwards the request to home application functionality 70, and in stage 1040 home application functionality 70 checks identity repository 95 to determine if identity information, including at least a username and password, for User2 at Service1 is found in identity repository 95. In the event that User2 has not given a username for Service1, in stage 1050 a message is sent to User2 requesting identity information and the identity information is obtained. In one embodiment, the message is sent by e-mail, or instant messaging. In the event that User2 has supplied identity information for Service 1, in stage 1060 home application functionality 70 calls an API such as: POST http://virtual-file-system/Service1/User1@Service1.com/xyz?action=share&shareWith=User2@Service1.com.

In stage 1070, home application functionality 70 calls Service1 with the generated API, optionally through adapter functionality 80. In one embodiment the call is of the form: POST http://imaginaryApi.google.com/User1@Service1.com/xyz?action=share&shareWith=User2@Service1.com.

In optional stage 1080, User2 is notified of the share and/or will see the shared file next time he logs into his virtual file system client 150. Service1 will subsequently display the file xyz as one of the files available to User2.

Sharing using Virtual File system Infrastructure

In another embodiment sharing is controlled by home application functionality 70, and in particular, the virtual file system portion thereof, and does not rely on third-party Web based services having appropriate sharing APIs. Virtual file system keeps a table in database 90 of sharing permissions.

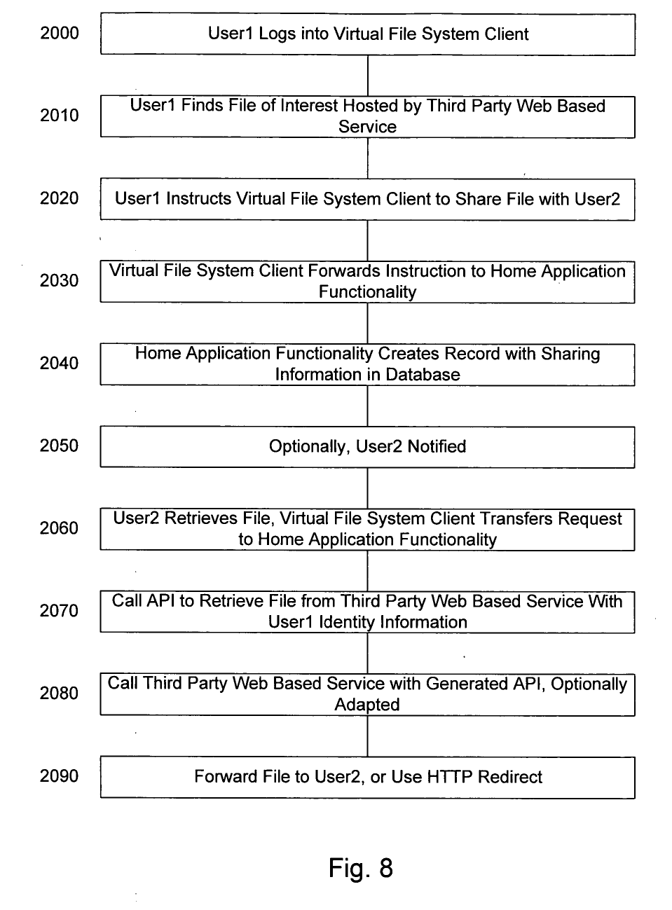

An embodiment of a workflow method, describing sharing files without using third party infrastructure is described below in relation to FIG. 8.

In stage 2000, User 1 logs into virtual file system client 150 and in stage 2010 uses virtual file system client 150 to find a file hosted by a first Web based service 40, denoted Service1, in User1's account: User1@Service1.com with file unique id xyz.

In stage 2020, User 1 tells virtual file system client 150 to share the file with User 2, also registered with home application functionality 70. In stage 2030, virtual file system client 150 communicates with home application functionality 70. In stage 2040 home application functionality, responsive to the received communication, is operative to create a put a record in a table in database 90:
Shared by user (User1)
Shared with user (User2)
Service provider (Service1)
Drive identifier (e.g. User1@Service1.com)
File identifier (e.g. xyz)

In optional stage 2050, User2 is notified of the share and/or will see the shared file next time he logs into his Virtual file system client

In stage 2060, User2 tries to retrieve the file from Service 1, and virtual file system client 150 of User2 transfers the request to home application functionality 70. In stage 2070, home application functionality 70 calls an API to retrieve the file from Service1 using identity information of User1 retrieved from identity repository 95 for authentication. In stage 2080, Service1 is called via its API, optionally adapted by adapter functionality 80. In stage 2090, the received file is forwarded to User2. In an alternative embodiment, the received file is transmitted directly from the third-party to User2's client using HTTP redirect.

### API

Preferably all operations from all drives are exposed using a REST style HTTP API. For example the URL for a file might be http://virtual-file-system.com/{service-provider}/{account-identifier-eg-username}/folder1/folder2/file-name

In one embodiment, WebDAV is used as an API performing most operations on such a URL. A quick summary of certain WebDAV specified HTTP methods includes:
*PROPFIND: find properties of a resource or collection: response body contains a Multistatus Response returned in XML representation (see Samples Below).
*PROPPATCH: Patch new properties, i.e add new properties “dead properties in day terminology” a dead property is only maintained by the server and the server is not responsible for the correctness of its syntax and semantics.
*COPY: copy a resource or collection from src to dst: Response Body is empty and only status returned
*MOVE: move a resource or collection from src to dst Response body is empty and only status returned
*MKCOL: Make Collection. i.e create a collection (which is also a resource) on the specified request URL Response body is empty and only status returned

Preferably alternative URLs are provided to access the same file by folder path and name, or by ID. In one embodiment, the following URLs might refer to the same file:
http://virtual-file-system.com/{service-provider}/{account-identifier-eg-username}/folder1/folder2/file-name
http://virtual-file-system.com/{service-provider}/{account-identifier-eg-username}/@byFileUniueUD/{file-id}

Preferably a file might belong to multiple collections—here are some example of collections that can be listed in certain embodiments:
GET http://virtual-file-system.com/{service-provider}/{account-identifier-eg-username}/folder1/folder
GET http://virtual-file-system.com/{service-provider}/{account-identifier-eg-username}/@byDateModified/today/{file-id}
GET http://virtual-file-system.com/{service-provider}/{account-identifier-eg-username}/@sharedBy/User1

Preferably some methods, such as search, are provided across accounts and even across service provider, e.g
GET http://virtual-file-system.com/Service1/@allAccount?keyword=part+of+file+name

In one embodiment all API responses come directly from the virtual file system portion of home functionality 70. In another embodiment some or all requests, especially for reading and writing file contents which requires heavy bandwidth, will be redirected to the service provider e.g. by the above URLs returning an HTTP redirect. It will be appreciated that the redirected URL might include authentication parameters, e.g. a digest of the URL and of the user's third-party username and password from the identity repository described below, which the client would not be able to generate on its own, since it might not have access to the user's third-party username's and passwords.

In the event that the API of the third party Web based service 40 is limited to HTTP GET and POST methods, other methods such as DELETE may be implemented using POST with the method in a parameter such as:
POST http:// . . . ?httpMethod=DELETE

In one embodiment, home based functionality 70 exhibits an extra layer which preprocesses incoming HTTP methods and substitutes the above to the more correct REST format:
DELETE http:// . . .

It will be appreciated that calls can be made using HTTPS instead of HTTP for extra security.

### Drive Directory

In certain embodiments, drives directory comprises a list of available third-party drives and all their metadata as described above.

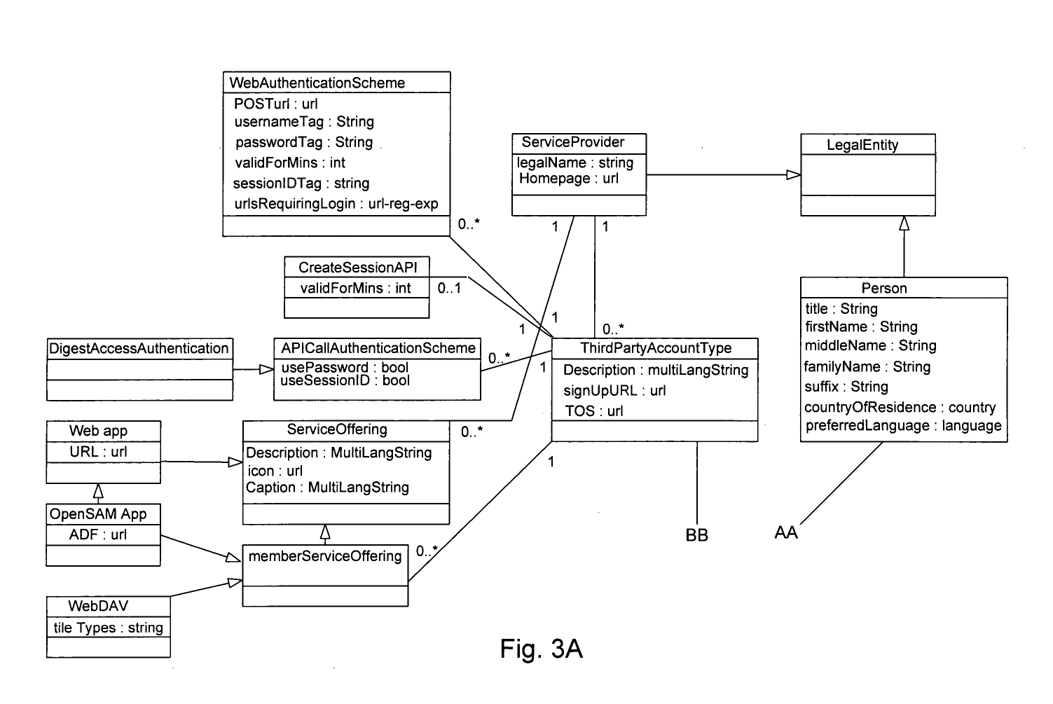

One possibility is to implement a drive directory as a special case of a more general web services app directory with an object-oriented model such as the one shown in FIG. 3A, the main concepts of which are descried as follows with an emphasis on capturing full information about how to do single sign-on to the service:
ServiceProvider: A company which provides Web services such as Google Inc. and Yahoo Inc.
ThirdPartyAccountType: A set of services you can sign up/on for, sometimes limited (usually one per service provider, however this is not restricted)
WebAuthenticationScheme: A scheme for doing SSO for browser Web pages associated with a ThirdPartyAccountType
CreateSessionAPI: Details of an API for supplying a username and password and receiving a session ID if session id's are supported by this ThirdPartyAccountType (some web services APIs prefer that username and password is presented once, usually securely over HTTPS, and then a sessionID is generated which is like a temporary password which may be used to authenticate subsequent API calls for a predetermined period of time).
APICallAuthenticationScheme: A scheme for signing/authenticating http calls to APIs associated with the ThirdPartyAccountType (if any) e.g. Digital Access Authentication
ServiceOffering: A service offered by a ServiceProvider (e.g. a web page, web app software-as-a-service, file storage e.g. with a WebDAV interface, other APIs etc.). A WebApp which is launched by pointing a browser at a URL is a particular case.

MemberServiceOffering: A service which requires an account and sign-on. Providing files or other resources using the WebDAV protocol is a particular case.

It will be appreciated by those skilled in the art that object-oriented inheritance can be conveniently used to add many specific schemes. By way of a non-limiting example DigitalAccessAuthentication is one way to authenticate API calls.

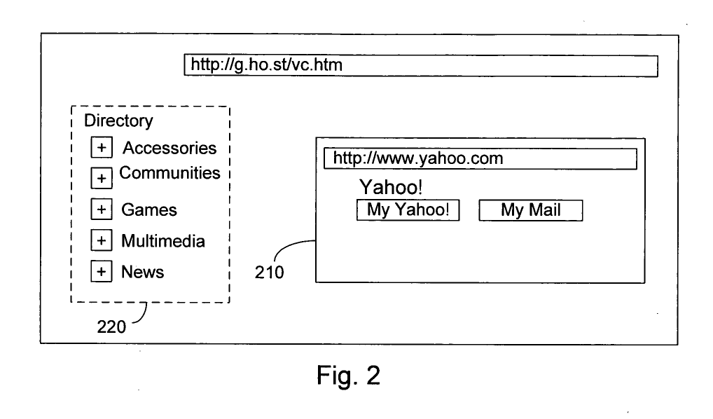

Referring to FIG. 2, which illustrates a home application with a third party Web based application embedded in an IFrame 210, according to certain embodiments of the invention, a sample simple GUI 220 for a directory of applications which may be specialized to a director of drives is illustrated. GUI 220 displays services categorized using a hierarchy of categories (like folders). Additionally metadata can be shown in mouse-overs, using context menu and other known GUI techniques. Search facilities may also be provided without exceeding the scope of the invention.

### Identity Repository

In one embodiment, database 90 comprises a repository of a user's third-party identity information. Preferably, a secure communications standard such as HTTPS is used for transmitting sensitive data such as passwords. An embodiment of an object-oriented data model and in its coupling to the components for automatically executing SSO and in its optional coupling to an application directory will now be further described in relation to FIG. 3B.

The identity repository described here is applicable to many types of services besides drives although for the purposes of the current invention it is possible to limit the concepts supported to just outbound SSO and just to drives, preferably including at a minimum the digest access authentication usually used with WebDAV.

Below are listed typical classes used, as shown in the diagram of FIG. 3B, the specific attributes are shown in the figures and only commented on when not self-explanatory:

ThirdPartyIdentity: The account login credentials (usually username and optionally password) which a the home application user supplies for a ThirdPartyAccountType;

ThirdPartySession: A temporary sessionID which has been generated for SSO to a third party—usually valid for a predetermined time period;

ThirdPartyAccountType: A ThirdPartyIdentity where the home application user has asked the home application to trust it in lieu of a home application login when hyperlinking from that service; and

InboundThirdPartyLogin: A ThirdPartyIdentity where the the home application user has asked to be able to provide that within the home application it in lieu of a home application login.

### Identity Repository API

In one embodiment, identity repository 95 has its own API. In one non-limiting example, using the HTTP REST style, the API may support the following functions:
Create a login (e.g. store login data to third-party GMail in repository): POST api.home-application/rest/userLogins/Fred/google/Fred@gmail.com?password=xyz&idSharing=private
Update a login
   Put api.home-application/rest/userLogins/Fred/google/Fred@gmail.com?password=newPw&idSharing=public
Get a user's logins by service providers with passwords:
   GET api.home-application/rest/userLogins/Fred/google
Get a session id for a login:
   GET api.home-application/rest/userLogins/Fred/google/Fred@gmail.com/sessionId
Sample return value: <homeAppAPIResponse . . . ><sessionId serviceProvider=“google” accountId=Fred@gmail.com sessionId=“id” expires=“{date-time}”></ . . .

### Outbound SSO to Web Service APIS

In the event that home application 70, or client code 110, responsive to a user input, is required to make API calls to a third-party virtual drive or other service, the API call will typically require authentication. One particular case is that the user has files stored with the third-party virtual drive which are accessible using an API such as WebDAV.

Cookies are not usually used, more often the calling party will somehow ‘digitally sign’ the call by attaching a digest of the call together with the username and password or using a sessionID, using cryptographical techniques.

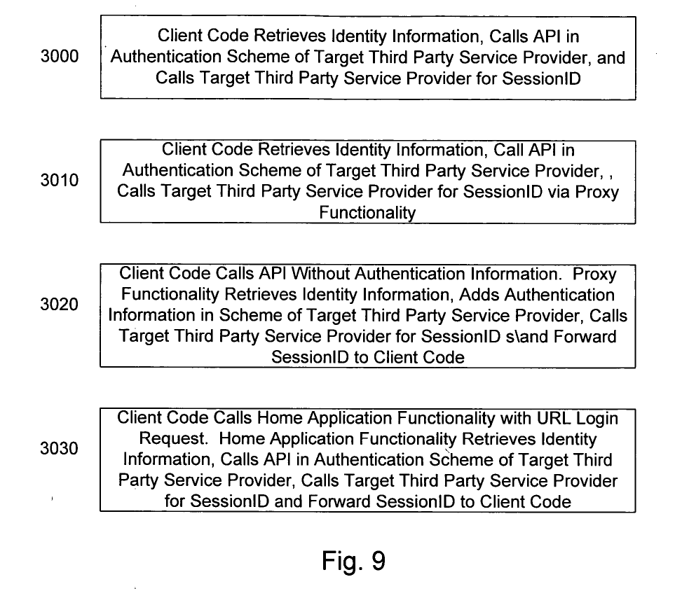

FIG. 9 illustrates a high level flow chart of a plurality of methods according to an embodiment of an invention to automatically generated a signed API call to a third party Web service provider.

In method 3000, if allowed by browser 100, an API generator of client code 110 generates a URL with authentication and calls third party Web service provider 40. In method 3010, client code 110 communicates with proxy functionality 60, and executes the generated API call via proxy functionality 60. Proxy functionality 60 is operative to call service provider 40 with signed the API call received from client code 110.

In method 3020, an API call generator of client code 110 generates a URL without authentication and calls proxy functionality 60. Proxy functionality 60, queries database 90, retrieves the required identity information, adds the authentication and forwards the request to third party Web service provider 40. Upon return of the sessionID, or other information, proxy functionality 60 forwards the received information to client code 110.

In method 3030, an API call generator of client code 110 calls server home application functionality 70, with the URL login request. Home application functionality 70, is equipped with an implementation of the WebDAV API, or other API as required, and generates the call to third party Web service provider 40, in cooperation with identity information stored on database 90. Upon return of the sessionID, or other information, proxy functionality 60 forwards the received information to client code 110.

In every one of these four methods there are common steps:

Before making a third-party API call the application directory stored on database 90, or copied into identity cache 130, is consulted to discover the API authentication scheme(s) supported by the third-party

If a sessionID is required, or desired, database 90 or identity cache 130 is consulted for an existing sessionID; and if not present the CreateSessionAPl record is consulted and an API call is generated to get a sessionID which is then preferably stored in database 90 and/or cached in identity cache 130.

The APICallAuthenticationScheme(s) is retrieved. In the event that more than one scheme is available, one is chosen according to what is preferred by the service provider or the protocol considered more secure or efficient by the home application. Each major protocol code is available to authenticate the API. Thus, advantageously, irrespective of the protocol code of the selected third party Web service provider 40, access can be achieved.

The authenticated API call is forwarded to third-party Web service provider 40.

### Using Session ID

In the event that the third-party Web service 40 is able to issue session IDs which are valid instead of a username and password for a period of time, the session ID is retrieved from the third-party Web service 40 by home application functionality 70 and forward to virtual file system client 150 without the security risk of sending the username and password to the client virtual file system client 150. The sessionID is preferably cached in identity cache 130 for as long as it is valid and used to authenticate subsequent calls to the third-party Web service 40 during that time.

### Using Third-Party Clients

The above has been described in an embodiment in which a single virtual file system client 150 is used to navigate all drives. In another embodiment, illustrated in FIG. 2, a third party client is embedded, preferably using an HTML IFrames 210 or a pop-up window.

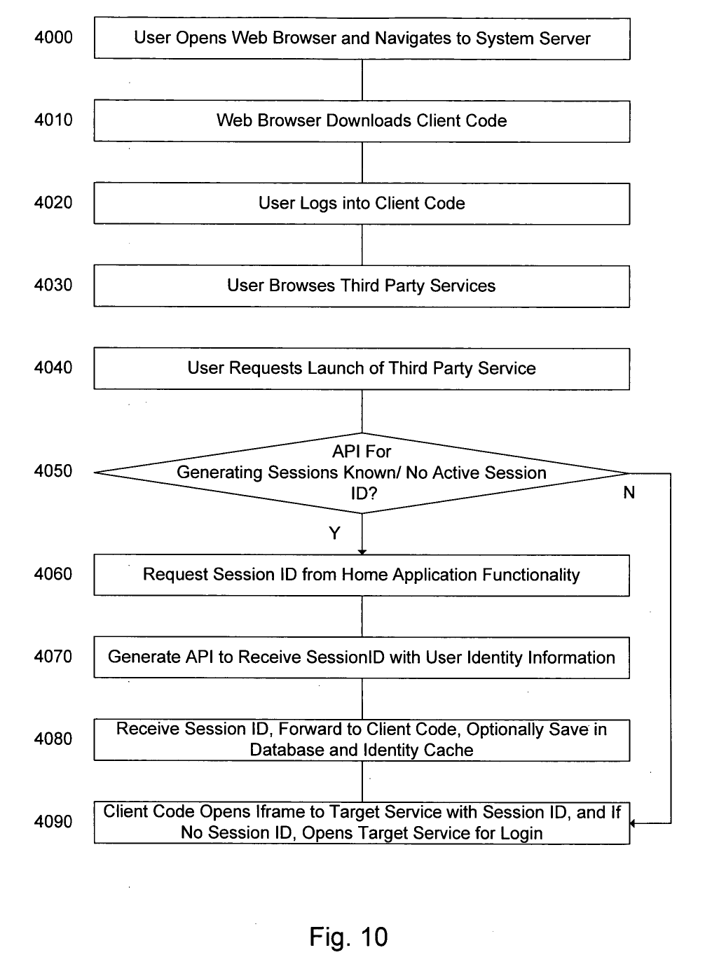

FIG. 10 illustrates a high level flow chart of a method of sharing files by embedding a third party client, in accordance with certain embodiments of the invention. In stage 4000 a user opens Web browser 100 and navigates to a domain associated with system server 20. In stage 4010 Web browser 100 downloads client code 110.

In stage 4020, the user logs in to client code 110, or an associated home application in which virtual file system client 150 is embedded. In stage 4030 the user browses third party services using API 220 within the virtual file system client 150, as illustrated in FIG. 2.

In stage 4040, the user issues a command to client code 110 to launch a third-party web application found in the directory, offered by a service provider, denoted FourthPartyInc and associated with URL http://fourth-party.com/AnotherService. In one embodiment, the service is an explorer for a files and folders

In stage 4050, client code 110 queries drives directory 97, via home application functionality 70, and determines that this service has an API for generating sessions IDs which may be used instead of Web login. The API is documented in a CreateSessionAPl object within the application directory, as illustrated in FIG. 3B, and described above in relation thereto. Optionally, client code 110 first checks identity cache 130, and if required queries database 90 via home application functionality 70, to see if a sessionID is currently known.

In the event that an API for generating session IDs is known, and no session ID is active, in stage 4060 a call is made to home application functionality 70 requesting a sessionID. In stage 4070, home application functionality 70 queries database 90, and in particular identity repository 95, for the user's identity information, including username and password, and sends them to third-party Web based service 40. In one embodiment the user's identity information is sent using POST https://fourth-party.com/api/getSessionID?username=NAME&password=xyz. In stage 4080 a sessionID is returned to home functionality 70, and forwarded to client code 110. Optionally, the session ID is further stored in database 90 and/or cached in identity cache 130.

In stage 4090, client software 1011 tells the browser to open IFrame 210 to the target service, with the retrieved session ID. In one embodiment, the IFrame 210 is opened to http://thirdparty.com/SomeService?sessionID=12345

For the predetermine amount of time that the session ID is valid, upon any new request by the user to access services from the third party Web based service 40, stage 4090 is repeated.

In the event that in stage 4050 an API for generating a sessionID is not known, in stage 4090 the service is called for user login. In the event that in stage 4050 a current sessionID is found, stage 4090 in which client software 1011 tells the browser to open IFrame 210 to the target service, with the retrieved session ID, is performed.

### Sign Up

In one embodiment, the identity management application may also help the user to create accounts with third parties.

At a minimum this might involve referring the user to the third-party's sign-up page opened e.g. in an IFrame or pop-up window. signUpUrl is an optional attribute of ThirdPartyAccountType described above in relation to FIG. 3B.

Preferably though third-party accounts may be made using an API call. For example an API may be a POST with tags. In one particular embodiment the POST comprises:
Preferred username;
Preferred password;
FirstName;
FamilyName;
DateOfBirth
Country;
PreferredLanguage;

and other parameters typical of registration. For each such parameter a tag name and an indicator of required/optional/not-supported may be added to the application directory in database 90 so that there is enough data for automatic sign-up to the third-party.

In one embodiment, home application functionality 70 digitally signs calls to the third-party sign-up API so that the third-party can trust the call. In one embodiment, home application functionality 70 further requires a “captcha” test to validate that the user is human before generating a sign-up request.

Thus, the present embodiments enable uniform access to files across multiple Web services, each of which hosts files and optionally folders but which have different paradigms, different user accounts, and different APIs.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A computer implemented virtual file system comprising a uniform representation of a plurality of file systems hosted by respective different third party Web based services.

2. A virtual file system according to claim 1, wherein said uniform representation comprises:
a uniform application programming interface (API); and
an adapter functionality arranged to adapt respective third party Web based services which do not support the uniform API to the uniform API.

3. A computer implemented virtual file system according to claim 2, wherein in the event that the particular API of one of the respective third party Web based services does note support HTTP methods other than GET and POST, at least one other command is implemented by using one of GET and POST with a parameter.

4. A computer implemented virtual file system according to claim 2, where the uniform API uses a single tree of URLs at the same domain for said plurality of file systems which have distinct domains.

5. A computer implemented virtual file system according to claim 1, further comprising a search capability operative across said plurality of file systems.

6. A computer implemented virtual file system according to claim 1, where each of said plurality of file systems is displayed as a virtual drive.

7. A computer implemented virtual file system according to claim 6, wherein each of said plurality of file systems exhibits metadata specifying its location and capabilities.

8. A computer implemented virtual file system according to claim 1, further comprising a client code arranged to navigate the virtual file system.

9. A computer implemented virtual file system according to claim 8, wherein the client code is implemented as an interactive web page.

10. A computer implemented virtual file system according to claim 8, wherein the client code is operative to add a file system responsive to a Universal Record Locator.

11. A computer implemented virtual file system according to claim 10, wherein said Universal Record Locator represents an address of one of a metadata for the file system and an application programming interface for the file system.

12. A computer implemented virtual file system according to claim 1, wherein said file system is further operative to enable a user to add tags from one master list of tags to files from each of said plurality of file systems.

13. A computer implemented virtual file system according to claim 1, wherein said file system is further operative to enable users to share files via said uniform representation.

14. A computer implemented virtual file system according to claim 13, further comprising a repository of identity information for users, wherein said file sharing is controlled by the respective third party Web based service hosting the file to be shared, and wherein the virtual file system is further operative to mark said file to be shared as shared by accessing the respective third party Web based service utilizing identity information from said repository.

15. A computer implemented virtual file system according to claim 13, further comprising a repository of identity information for users, wherein the virtual file system is operative to retrieve said file to be shared by a second user by accessing the respective third party Web based service utilizing identity information of the owner of said file from said repository.

16. A computer implemented virtual file system according to claim 14, wherein the identity repository is coupled to a single sign on functionality.

17. A computer implemented virtual file system according to claim 16, wherein the single sign functionality supports multiple protocols.

18. A computer implemented virtual file system according to either claim 17, wherein one of the protocols is digest access authentication.

19. A computer implemented method of uniform representation of a plurality of file systems hosted by respective different third party Web based services, comprising:
receiving commands to access a file hosted by one of the respective different third party Web based services;
preparing the command utilizing a uniform application programming interface (API);
adapting, in the event that said one of the respective different third party Web based services does not support said uniform API, to an API supported by said one of the respective different third party Web based services; and
transmitting the prepared command in said supported API to said one of the respective different third party Web based services.

20. A computer implemented method according to claim 19, wherein in the event that the particular API of said one of the respective third party Web based service does note support HTTP methods other than GET and POST, said adapting comprises using one of GET and POST with a parameter.

21. A computer implemented method according to claim 19, where the uniform API uses a single tree of URLs at the same domain for said plurality of file systems which have distinct domains.

22. A computer implemented method according to claim 19, further comprising:
enabling a search operative across said plurality of file systems.

23. A computer implemented method according to claim 19, wherein each of said plurality of file systems is displayed as a virtual drive.

24. A computer implemented method according to claim 19, wherein each of said plurality of file systems exhibits metadata specifying its location and capabilities.

25. A computer implemented method according to claim 19, further comprising:
providing a client code arranged to navigate the virtual file system.

26. A computer implemented method according to claim 25, wherein the client code is implemented as an interactive web page.

27. A computer implemented method according to claim 25, wherein the client code is operative to add a file system responsive to a Universal Record Locator.

28. A computer implemented method according to claim 27, wherein said Universal Record Locator represents an address of one of a metadata for the file system and an application programming interface for the file system.

29. A computer implemented method according to claim 19, further comprising:
enabling a user to add tags from one master list of tags to files from each of said plurality of file systems.

30. A computer implemented method according to claim 19, further comprising:
enabling users to share files via said uniform representation.

31. A computer implemented method according to claim 30, wherein said enabling users to share files comprises:
providing a repository of identity information for users;
accessing the respective third party Web based service utilizing identity information from said repository; and
marking said file to be shared.

32. A computer implemented method according to claim 30, wherein said enabling users to share files comprises:
providing a repository of identity information for users; and
retrieving said file to be shared by a second user by accessing the respective third party Web based service utilizing identity information of the owner of said file from said repository.

33. A computer implemented method according to claim 32, wherein the identity repository is coupled to a single sign on functionality.

34. A computer implemented method according to claim 33, wherein the single sign functionality supports multiple protocols.

35. A computer implemented method according to either claim 34, wherein one of the protocols is digest access authentication.
